(19) United States
(12) Patent Application Publication
(10) Pub. No.: US 2023/0219109 A1
(43) Pub. Date: Jul. 13, 2023

(54) HEAD FOR DISPENSING A FLUID PRODUCT AND ASSOCIATED FLUID PRODUCT BOTTLE

(71) Applicant: SILGAN DISPENSING SYSTEMS LE TREPORT, LE TREPORT (FR)

(72) Inventor: Thomas PRUVOST, SAINT QUENTIN LA MOTTE (FR)

(21) Appl. No.: 17/927,317

(22) PCT Filed: May 25, 2021
(86) PCT No.: PCT/EP2021/063854

§ 371 Date: Nov. 22, 2022

(30) Foreign Application Priority Data
May 29, 2020 (FR) FR2005730

(51) Int. Cl. B05B 11/10

(52) U.S. Cl. CPC B05B 11/1054; B05B 11/1025

(57) ABSTRACT

This disclosure relates to a dispensing head for a fluid product, comprising: a manually operable pusher, the pusher being configured to move between a high position (PH) and a low position (PB), and a nozzle for dispensing the fluid product made of a resilient material. The dispensing head is configured so that, during the movement of the pusher between the high position (PH) and the low position (PB), the nozzle passes from a closed position in which the nozzle is sealed, to an open position allowing the dispensing of the fluid product by deformation of the nozzle under the effect of a stress exerted by the support and/or a release of a stress exerted by the pusher.

### TECHNICAL FIELD OF THE INVENTION

The invention relates to a head for dispensing a fluid product. The invention also relates to a bottle of fluid product equipped with such a dispensing head.

In the context of the invention, the fluid product may be any cosmetic product, including any pharmaceutical lotion or other product.

### TECHNICAL BACKGROUND

The bottles of fluid product typically comprise a tank for the fluid product with a rigid neck at the upper portion delimiting an opening into which the system for dispensing the fluid product is inserted.

The dispensing system comprises a pump that can be operated by a user by means of a pusher. When the user exerts a pressure on the pusher, a dose of the product is dispensed from a dispensing orifice of a nozzle fitted in said pusher.

Typically, the dispensing orifice is permanently open. The product remaining in a communication channel between the pusher and the pump between two uses, i.e. when the pump is at rest, is therefore in contact with the external environment even before it is dispensed. It can therefore dry out or become contaminated with microbial agents.

More recently, nozzles have been proposed that comprise a slot as the dispensing orifice of the product, the opening of which depends on the pressure exerted by the product leaving the pump.

In such a configuration, the slot cannot be perfectly sealed, as it would not be possible to prime the pump and expel the air contained in the pump and the head of the tank during the first use. This is because in the presence of air, the increase of the pressure in the air following the operating of the pump is too small to open the slot so that the air would never be able to escape and the pump to be primed. Because of this deliberately imperfect sealing, such a configuration delays drying out but does not completely eliminate it.

Nozzles have also been proposed that are mechanically controlled to open upon operating. Such nozzles are, for example, equipped with a link mechanism comprising a needle configured to obstruct the dispensing orifice of the product when the device is at rest and to perform a retracting movement upon operating of the pusher, thereby allowing fluid to be dispensed through the orifice. However, this type of nozzles is more complex in design with a large number of components and therefore more expensive. In addition, this severely limits the design possibilities for the pusher.

### SUMMARY OF THE INVENTION

The invention allows to overcome the above disadvantages and provides a dispensing head for the fluid product in which the opening of the nozzle is not dependent on the pressure exerted by the product coming from the pump and the tank, which is simple in design, requires a limited number of components and is inexpensive. In this regard, the invention proposes a dispensing head for the fluid product, a manually operable pusher, said pusher being configured to move between a high position and a low position, a dispensing nozzle for the product made of a material of elastic material.

The dispensing head is configured so that, when the pusher is moved between the high position and the low position, the nozzle passes from a closed position in which said nozzle is sealed to an open position allowing the dispensing of said product by deformation of said nozzle under the effect of a stress exerted by the support or of a release of a stress exerted by the pusher.

Thus, the opening of the nozzle of the invention does not depend on the pressure exerted by the product to be dispensed but on the stress exerted by a support on said nozzle or on a release of a stress exerted by the pusher during the movement of said pusher between the high position and the low position. The nozzle can therefore be closed completely tightly, even without affecting the priming. In addition, the nozzle can remain completely sealed, in particular between two uses of the device, since the elastic material of which it is made allows it to return to its initial, i.e. resting, configuration after the product has been dispensed. The inside of said nozzle and the product contained in the bottle are thus protected from contamination. Furthermore, the nozzle according to the invention is simple to manufacture since its opening is “activated” by simply bringing the nozzle into contact with the support and the resulting stress or release of a stress exerted by the pusher. The design of the nozzle of the invention is therefore simple and its design possibilities are therefore varied with limited cost.

In addition, as the fluid product is more specifically a lotion, it is desirable that it is dispensed before being compressed and/or pressurised. This is because the lotion may have a fragile formula which could, when put under pressure, degrade. The nozzle according to the invention allows to protect the lotion, whatever its formula, since the opening of said nozzle is mechanically controlled, it does not involve pressurisation.

According to various characteristics of the invention which may be taken together or separately:
the dispensing head comprises the support;
said support is configured to support a pump of the dispensing head;
said support supports said pump;
said head is configured so that, in the low position, the pusher activates the pump;
said pusher is mounted so as to be axially movable relative to the pump support;
said pusher is locked in rotation relative to the pump support;
the nozzle protrudes from an outer surface of the pusher;
said nozzle comprises a slot,
the nozzle comprises a dispensing portion equipped with said slot and a conduit opening onto the slot;
said slot is configured to deform, in particular along a circumferential direction, to allow the nozzle to pass from the closed position to the open position,
the dispensing head is configured so that said nozzle is subjected to opposing forces involving the pusher so as to cause the slot to open or to maintain the slot closed by pinching,
the nozzle is made of a thermoplastic elastomer material with a shore hardness of between 15 and 90 shore A,
the nozzle is attached to the pusher,
according to a first embodiment, the nozzle passes from the closed position to the open position by deformation of said nozzle under the effect of the stress exerted by the support,
the nozzle comprises a means, referred to as movable, capable of causing the nozzle to pass from the closed position to the open position;
said movable means consists of a boss located under and in contact with the nozzle;
the boss is integral with the nozzle;
said boss comprises a surface adapted to come against the support;
the nozzle comprises a flexible web pinched between the boss and an upper peripheral border of the nozzle;
said flexible web comprises the slot,
the slot extends in a direction substantially identical to a direction of movement of the pusher;
said slot extends in the extension of the boss;
said slot extends substantially vertically;
said slot is configured to deform to allow the nozzle to pass from the closed position to the open position under the effect of a force transmitted by the boss;
the support further comprises a means, referred to as stationary, able to cause the nozzle to pass from the closed position to the open position;
the support comprises an upper rim with the boss facing it;
said stationary means extends from the upper rim;
the stationary means is integral with the support;
the pusher comprises a reception housing for the nozzle;
said nozzle is configured to be press-sleeved into said housing;
a projecting extension of the nozzle corresponds substantially to a width of the upper rim of the pump support;
said dispensing portion of the nozzle comprises two housings extending on either side of said conduit opening onto the slot;
the nozzle comprises an elastic member comprising two elastic flexible legs adapted to be inserted into said housings;
a distance between the flexible legs is less than a distance between the housings,
according to a second embodiment, the nozzle passes from the closed position to the open position as a result of a release of a stress exerted by the pusher,
said dispensing head further comprises an insert configured to exert a stress in the opposite direction to the stress exerted by the pusher to maintain the nozzle closed at rest,
said pusher comprises a tongue, said insert being equipped with a deformable leg or legs, said leg or legs causing a force so that the insert exerts a stress on the nozzle in the opposite orientation to a stress exerted by the tongue,
the legs are adapted to deform when a pressure is exerted on said pusher, said tongue ceasing to exert on the nozzle the stress in the opposite orientation to the stress exerted by the insert, when the pusher is operated,
the dispensing head further comprises a dispensing pump equipped with a spring, said spring having a stiffness constant selected such that upon operating of the pusher, a force exerted by the legs is less than a force exerted by the spring,
the slot extends in a direction substantially transverse to a direction of movement of the pusher,
said slot passes through a plane, referred to as plane of the slot, the direction of the stresses exerted by said tongue and said legs being orthogonal to the plane of the slot.

The invention further relates to a bottle for dispensing a fluid product comprising a tank in which a product is intended to be packaged and a neck equipped with a dispensing head as described above.

### BRIEF DESCRIPTION OF THE FIGURES

Further objects, characteristics and advantages of the invention will become clearer in the following description, made with reference to the attached figures, in which:

FIG. 1 illustrates a diametrical sectional view of the dispensing head according to a first embodiment of the invention, with the pusher in the high position;

FIG. 2 shows a rear face view of the nozzle equipping the dispensing head in FIG. 1;

FIG. 3a shows a perspective view of the dispensing head in FIG. 1 with the pusher in the high position;

FIG. 3b shows a perspective view, from a different angle, of the dispensing head in FIG. 1, with the pusher in the low position;

FIG. 4a shows a front side view of the nozzle in FIG. 2;

FIG. 4b shows a front side view of the nozzle according to an alternative embodiment in accordance with the first embodiment of the invention,

FIG. 5 shows a lateral view of a dispensing head according to an alternative embodiment of the first embodiment of the invention;

FIG. 6a shows a perspective view of a nozzle according to a variant of the first embodiment of the invention;

FIG. 6b shows a sectional view, seen from above, of the nozzle shown in FIG. 6a;

FIG. 7 shows a diametrical cross-section of the dispensing head according to a second embodiment of the invention, with the pusher in the high position,

FIG. 8 is an exploded view of the dispensing head shown in FIG. 7: FIG. 8a illustrating a nozzle; FIG. 8b, illustrating an insert; and FIG. 8c illustrating a pusher.

### DETAILED DESCRIPTION OF THE INVENTION

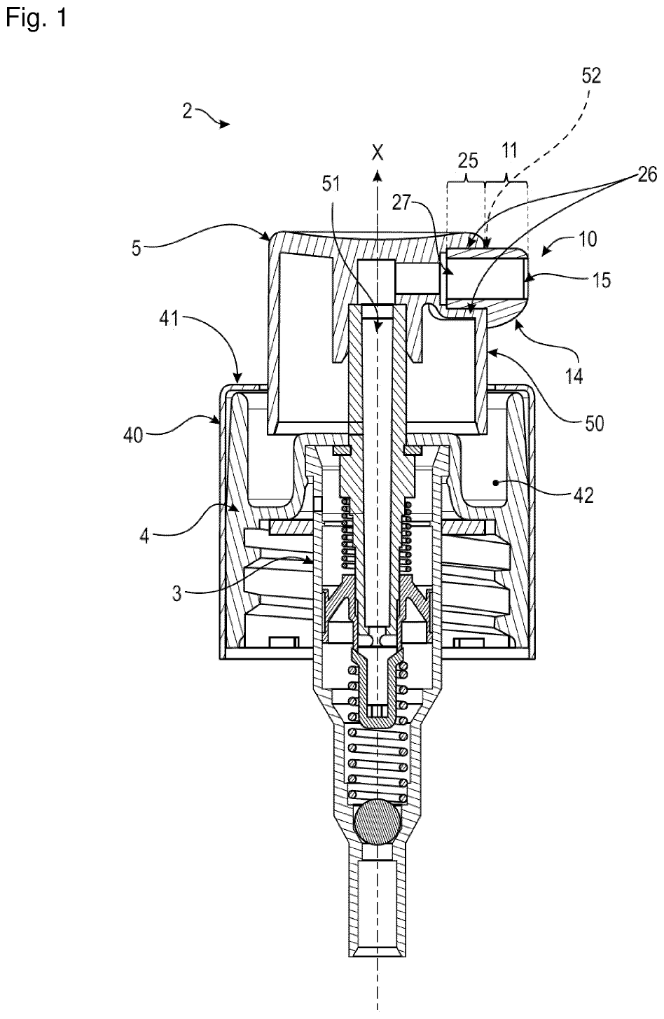

With reference to FIG. 1, the invention relates to a head 2 for dispensing fluid product. The fluid dispensed is in particular a liquid, in particular a lotion.

Said dispensing head is intended to equip a bottle, not shown, configured to contain the product to be dispensed. The bottle can be oriented either “head down” or “head up”. Thus, the terms “upper” or “lower” should not be considered as limiting. The figures correspond to a head up configuration.

The fluid product may be any cosmetic, pharmaceutical product or other product that can be usefully preserved in the bottle. The fluid can be in direct contact with a tank in the bottle. However, the fluid may be contained in a flexible pouch located within said tank so that it is not in contact with the tank but with said flexible pouch.

The tank can be either rigid or deformable. However, the tank comprises, at the level of an upper portion, a neck and an opening formed in said neck. The neck is preferably rigid.

The dispensing head 2 is preferably equipped with a dispensing pump 3.

The dispensing pump 3 comprises, in the illustrated example, a dosing chamber and a sprinkler adapted to move within the dosing chamber.

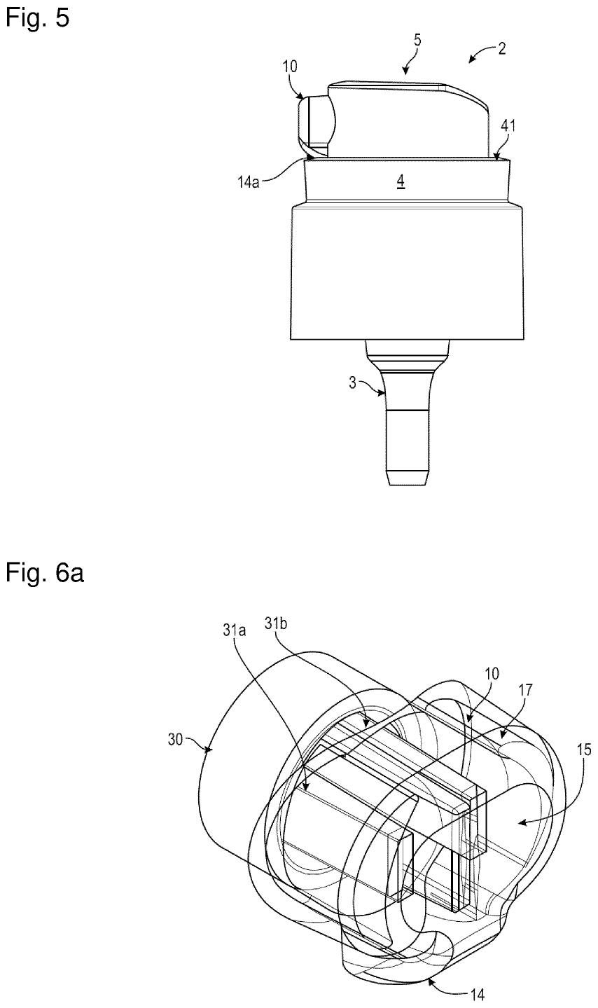

The dispensing head 2 comprises a support 4, a manually operable pusher 5 and an elastic nozzle 10 which will be described in more detail below. Advantageously, the support 4 serves to support the pump 3. It is tubular in shape, in particular of revolution. It extends along a central longitudinal axis X corresponding to a median axis of the bottle. In addition, the support 4 may be used to maintain the dispensing pump 3 immobile at the level of a neck of the tank by means of an attachment system. Preferably, the attachment system may comprise removable attachment means allowing an easy dismounting and re-mounting of the dispensing head at the level of said neck, for example by unscrewing/screwing and/or snapping in. Said support 4 may be in the form of a ring on which a band 40 is mounted. Alternatively, the support 4 may be in the form of a ring only, i.e. without a trim band 40, as shown in FIG. 5.

The pusher 5 is mounted so that it can move axially in relation to the support 4. It leads to the sprinkler on which it is able to abut. In addition, an empty interior volume 42 used for hosting the pusher 5 is reserved within the support 4. In FIG. 1, the pusher 5 is in high position P_{H}. At the high position P_{H}, the pusher 5 is not fully inserted into the empty interior volume 42. The pusher 5 therefore protrudes significantly with respect to an upper rim 41 of the band 40 so that only one segment of the volume occupied by said pusher remains at the level of the support. The dispensing nozzle 10 is therefore located at a good distance from the upper rim 41 of the band 40. In this configuration, the pump 3 is at rest since the piston is not solicited.

The pusher 5 is configured to pass from the high position P_{H} to a low position P_{B}. In the low position P_{B}, the pusher 5 is fully inserted into the empty volume 42. The pusher 5 does protrude with respect to the upper rim 41 of the band 40, but to a lesser extent (shown in FIG. 5). Thus, in the low position P_{B}, the dispensing nozzle 10 is in direct contact with the upper rim 41. The pusher 5 is lowered as far as the initial distance between the nozzle 10 and the upper rim 41 at the high position P_{H}.

The movement of the pusher 5 from the high position P_{H} to the low position P_{B} allows to activate the pump 3 by means of the sprinkler so that the pump 3 is primed or the product is dispensed. In other words, this movement results in the operating of the dispensing head 1. Means may be provided to lock the rotation of the pusher 5 as we shall see below.

The nozzle 10 for dispensing the product is in fluidic communication with the pump 3 by means of an outlet conduit 51 of the pusher 5. The pusher 5 comprises a housing 52 for receiving the nozzle 10. The reception housing 52 is suitably sized to allow for forced insertion of said nozzle 10 into said reception housing 52. In the illustrated example of embodiment, the reception housing 52 is substantially tubular in shape and complementary to a peripheral border 26 of a recessed segment 25 of the nozzle 10. In such a configuration, when the nozzle 10 is forcibly inserted into the reception housing 52, the peripheral border 26 is pressed against an inner lateral surface of said reception housing 52. Here, a rear face 27 is spaced from a bottom of the reception housing 52.

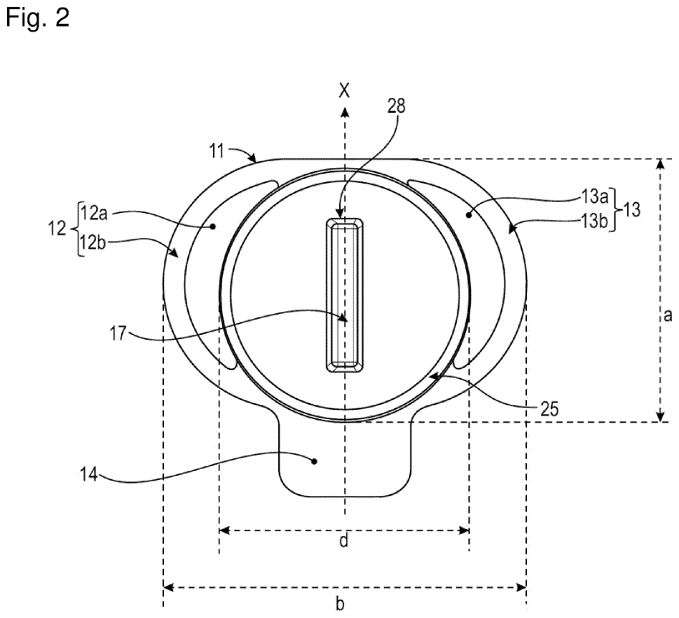

The nozzle 10 is not completely recessed in the reception housing 52. In fact, only the recessed segment 25 is completely inserted into the reception housing 52. The nozzle 10 protrudes with respect to an outer lateral surface 50 of the pusher. More specifically, the nozzle 10 comprises a segment 11 projecting with respect to the outer surface 50. The recessed segment 25 is located upstream of the projecting segment 11 in the direction of the flow of the product. As best illustrated in FIG. 2, the projecting segment 11 has a substantially oblong shape with a minor axis a and a major axis b having larger dimensions than a diameter d of the recessed segment 25. In the illustrated example of embodiment, the nozzle 10 comprises two ears 12, 13 closed at the front and located on either side of the projecting segment 11. A recess 12a, 13a is embodied in each of the ears 12, 13, which allows to limit the amount of material used in the manufacture of the nozzle 10. Each of said ears 12, 13 comprises a proximal border 12b, 13b configured to abut the pusher 5, thereby allowing to maintain the projecting segment 11 outside the reception housing 52.

The nozzle 10 comprises a passage conduit 28 for the fluid located in the extension of the conduit 51 of the pusher 5. Here it is rectangular in cross-section, with the long sides of said conduit 28 oriented along the axis X.

FIGS. 1 to 6b illustrate a first embodiment of the invention which will be described in the following sections.

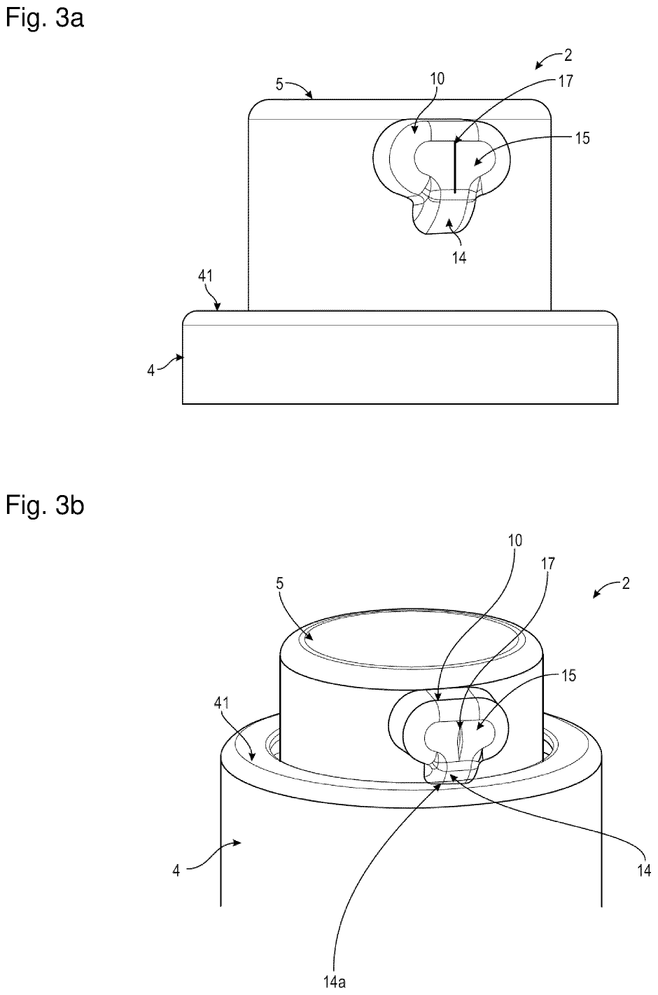

With reference now to FIGS. 3a and 3b, the dispensing head 2 is configured so that, when the pusher 5 is moved between the high position P_{H} (configuration illustrated in FIG. 3a) and the low position P_{B} (configuration illustrated in FIG. 3b), the elastic nozzle 10 passes from a closed position in which said nozzle is sealed to an open position allowing dispensing of said product by deformation of said nozzle 10 under the effect of a stress exerted by the support 4. The opening of the nozzle 10, and therefore the dispensing of the product, is thus controlled solely by the stress exerted by the support 4 on the nozzle 10 during the movement of the pusher 5. In other words, the opening of the nozzle 10 is controlled mechanically and without additional part.

The more the pusher 5 is moved towards the support 4, the greater the stress exerted by the support 4. In other words, when the pusher 5 is in the high position P_{H}, the stress is zero and the nozzle 10 is in the closed position, and when the pusher 5 reaches the low position P_{B}, the stress increases as the pusher 5 is pressed against the support 4 and the nozzle 10 passes to the open position. The nozzle 10 opens when it is in contact with the support 4. A continuous pressure can be exerted on the pusher 5 to increase an opening section of the nozzle 10. However, the opening occurs the instant after the contact of said nozzle 10 with the support 4.

Advantageously, the dispensing nozzle 10 comprises a means 14, referred to as movable, capable of causing the nozzle to pass from the closed position to the open position. The means 14 is referred to as movable because, although it has a stationary position in relation to the pusher 5, the axial movements of the pusher 5 along the axis X necessarily induce changes in its relative position in relation to the support 4, which is stationary in use.

In the illustrated example of embodiment, the means 14 referred to as movable consists of a boss. The boss 14 has a curved shape. It protrudes along the axis X from a lower wall of the conduit 28 of the nozzle, at its protruding segment. It is therefore turned towards the support 4. In other words, it protrudes in a direction substantially identical to the direction of movement of the pusher 5. In a preferred embodiment, the boss 14 is integral with the nozzle 10. In other words, the boss 14 is in one part with said nozzle 10, which has the advantage of simplifying the manufacturing method of the dispensing head 2, since the nozzle 10 can be moulded in a single part. According to another embodiment of the invention not shown, the boss 14 may be located below and in contact with the nozzle 10, i.e. may not be integral with the nozzle, without being of the same material. Alternatively, the boss 14, again without being integral with the nozzle 10, can be made of the same material as the latter.

In either of the above embodiments, the boss 14 is positioned on the side of the nozzle 10 facing the support 4, in particular on the upper rim 41 of said band 40. Thus, when the pusher 5 is moved from the high position P_{H} (configuration illustrated in FIG. 3a) to the low position P_{B} (configuration illustrated in FIG. 3b), the boss 14 is necessarily brought into contact against the support 4, in particular on the rim 41 of the band. In this case, the boss 14 comprises a surface, referred to as abutment surface 14a, adapted to come against the support 4. The abutment surface 14a forms an abutment with said upper rim 41. The value of this particularly advantageous positioning will be better understood in the following sections. It should be noted that, due to the configuration of the boss 14, it also helps to maintain the projecting segment 11 outside the reception housing 52, in addition to the two ears 12, 13. Said boss 14 has a rounded, substantially quarter-circular or elliptical shape.

In this regard, it may also be noted that a projecting extension of the nozzle 10 may correspond substantially to a width of the upper rim 41. In other words, the radial extension of said boss 14 (with respect to the axis X) may correspond substantially to a width of the upper rim 41. However, this is not mandatory, the most important thing being that the abutment surface 14a is of sufficient size as shown in FIG. 3b.

Particularly advantageously, the nozzle 10 comprises a flexible web 15 pinched between the boss 14 and an upper peripheral border 16a of the nozzle 10. Indeed, the boss 14, the flexible web 15 and the upper peripheral border 16a are located one above the other in that order along the axis X. The web 15 is also located side by side with lateral peripheral borders 16b, 16c which extend on either side of said web 15. The upper 16a and lateral 16b, 16c borders together form a peripheral border 16 of the nozzle 10. The web 15 is substantially plane and thin, while the peripheral border 16 forms a thick edge extending back to the pusher.

The web 15 is configured to deform. This is because the web 15 is thinner than the boss 14 and the upper peripheral border 16a. It has a reduced thickness compared to a thickness of the boss 14 and a thickness of the peripheral border 16a. The thinness of the web 15 confers it flexibility. In any case, the web 15 is softer than the boss 14 and the upper peripheral border 16a. Thus, when the pusher 5 is moved from the high position P_{H} (configuration illustrated in FIG. 3a) to the low position P_{B} (configuration illustrated in FIG. 3b), the web 15 being pinched between the boss 14 and the upper peripheral border 16a, it is configured to deform under the effect of a force transmitted by the boss, itself resulting from the stress exerted by the pump support 4 on said boss 14.

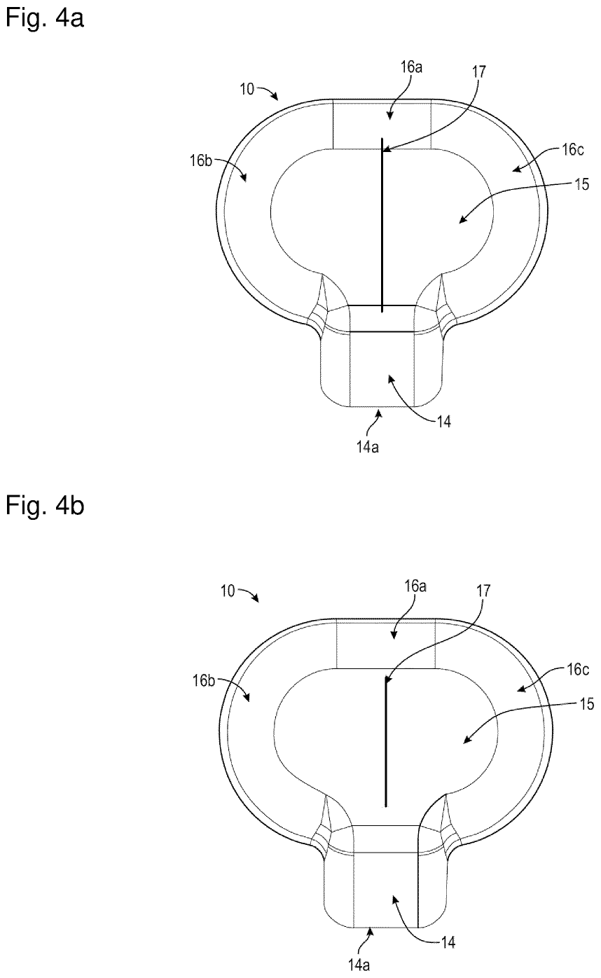

The flexible web 15 comprises a slot 17 extending in a direction substantially identical to a direction of movement of the pusher 5. As shown in FIG. 2, the conduit 28 opens directly into the slot 17. The slot 17 extends along the axis X as an extension of the boss 14. It may extend along the entire length of the flexible web 15 in direct contact with the boss 14 and the upper peripheral border 16a, as illustrated in FIGS. 3a, 3b and 4a. The slot is then larger than a length of the conduit 28 of the nozzle. Alternatively, it extends partially along the web 15 without contacting edges of the web 15, as shown in FIG. 4b.

Because of its configuration on the flexible web 15, the slot 17 is cause to deform with said flexible web. More precisely, said slot 17 is configured to deform, along a circumferential direction, to allow the nozzle 10 to pass from the closed position to the open position under the effect of a force transmitted by the boss 14. The slot 17 necessarily deforms in a circumferential direction, as illustrated in FIG. 3b, since on the one hand it extends in the direction of movement of the pusher 5 and on the other hand it deforms with the flexible web 15 under the effect of the force transmitted by the boss in this same direction, i.e. the direction of movement of the pusher 5.

The elasticity of the nozzle 10, i.e. its capacity to deform under the effect of the stress exerted by the support 4, is therefore essential in the scope of the present invention. Advantageously, the nozzle 10 is preferably made of a thermoplastic elastomer material. Preferably, this material has a shore hardness of between 15 and 90 shore A. The elastic material of which the nozzle 10 is made allows the slot 17 to remain completely sealed, in particular between two uses of the device, when it is not subjected to any stress (FIG. 2). Thus, the product remaining in the conduit 28 of the nozzle between two uses is protected from contamination.

According to another embodiment of the invention, not illustrated, the support 4 may further comprise a means, referred to as stationary, capable of causing the nozzle 10 to pass from the closed position to the open position. The stationary means has a similar if not identical function to the boss 14 by being placed opposite the nozzle along the axis X. However, unlike the boss 14, the stationary means extends from the support 4. Specifically, it extends from the peripheral rim 41, so its relative position does not change.

Preferably, the stationary means consists of a boss. The boss can be integral with the support 4. In other words, the boss is in one single part with the support 4.

When combined, the boss located on the support is intended to cooperate with the boss 14. In this respect, it may therefore take any appropriate form to allow such cooperation. Thus, when the pusher 5 is moved from the high position P_{H} (configuration shown in FIG. 3a) to the low position P_{B} (configuration shown in FIG. 3b), the boss 14 is necessarily brought into contact against the boss of the support 4, in this case by means of its abutment surface 14a. In this embodiment, the abutment surface 14a forms an abutment with said boss of the support 4.

In this respect, the pusher 5 and the pump support 4 are preferably configured so that the pusher 5 is locked in rotation relative to said pump support 4. This configuration has the advantage to allow that the nozzle 10 always remains opposite the boss of the support 4.

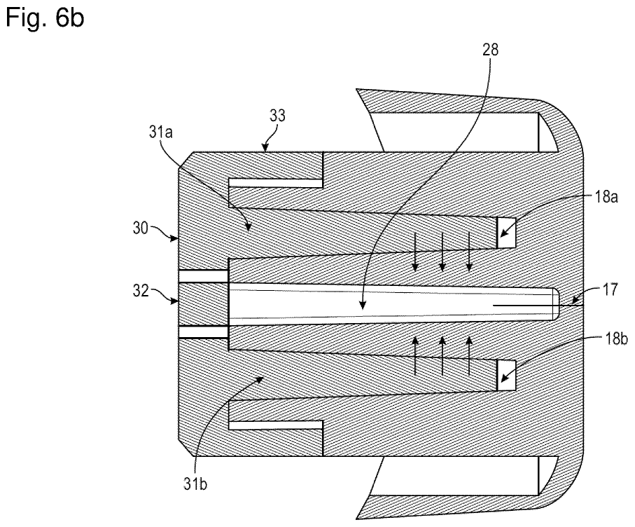

With reference to FIG. 6a, a variant of the nozzle equipping the dispensing head according to the invention is illustrated. In this configuration, the nozzle 10 comprises a dispensing portion equipped with said slot 17 and the conduit 28 opening onto the slot 17. The nozzle 10 further comprises an elastic member 30. The latter allows the nozzle to be sealed more effectively at rest. In this respect, the elastic member 30 comprises two flexible legs 31a, 31b, elastic, configured to be inserted between two housings 18a, 18b respectively of said dispensing portion. As can be seen more clearly in FIG. 6b, the lateral housings 18a, 18b are located on either side of the conduit 28 providing the fluidic communication between the communication channel 51 of the pusher and the slot 17.

Advantageously, the flexible legs 31a, 31b are separated by a distance d′ less than a distance d″ separating the housings 18a, 18b. In other words, the spacing between the flexible legs 31a, 31b is less than the spacing between the housings 18a, 18b. Thus, when the flexible legs 31a, 31b are inserted into the lateral housings 18a, 18b, they exert a force directed towards the centre of the dispensing portion (illustrated by arrows oriented towards the conduit 28 in FIG. 6b). This allows to increase the stiffness of the slot 17 and favours the tight closure of the slot at rest. This does not prevent the opening of the slot 17 as this is mechanically controlled.

The distances d′ and d″ must therefore be chosen so as to allow the insertion of the flexible legs 31a, 31b into the housings 18a, 18b while allowing said flexible legs to exert a stress on the slot 17. Indeed, a difference, A, that is too great between d′ and d″ will not allow the insertion of the flexible legs, while a difference A that is too small will not allow the flexible legs to exert sufficient stress on the slot.

In addition, the elastic member 30 preferably comprises a conduit 32 allowing the passage of the fluid between the communication channel 51 of the pusher and the conduit 28 of the dispensing portion. The conduit 32 of the elastic member extends in the extension of the conduit 28.

The elastic member 30 may also comprise a peripheral border 33 allowing to prevent any clearance between the dispensing portion and said elastic member. In this regard, the peripheral border 33 is configured so as to take on a rim of the dispensing portion. In the cross-sectional plane shown in FIG. 6b, the peripheral border extends around the entire outer perimeter of the flange of the dispensing portion, i.e. it extends in an annular manner.

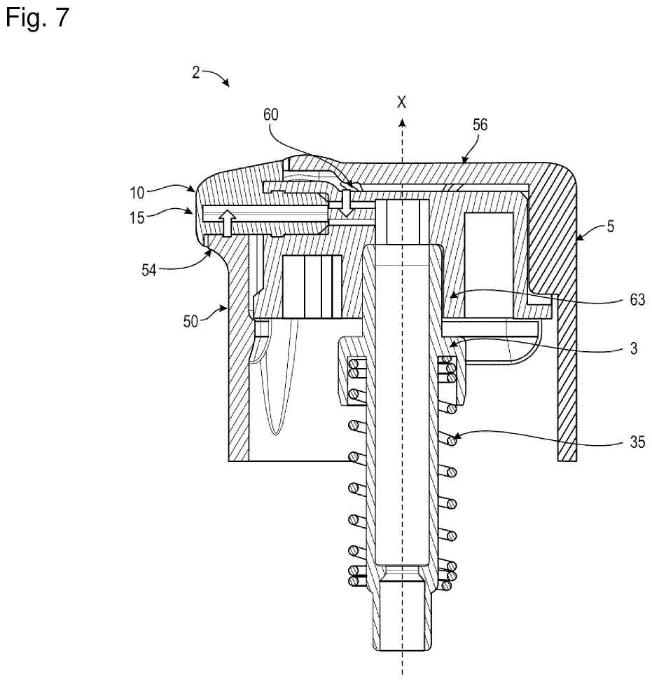

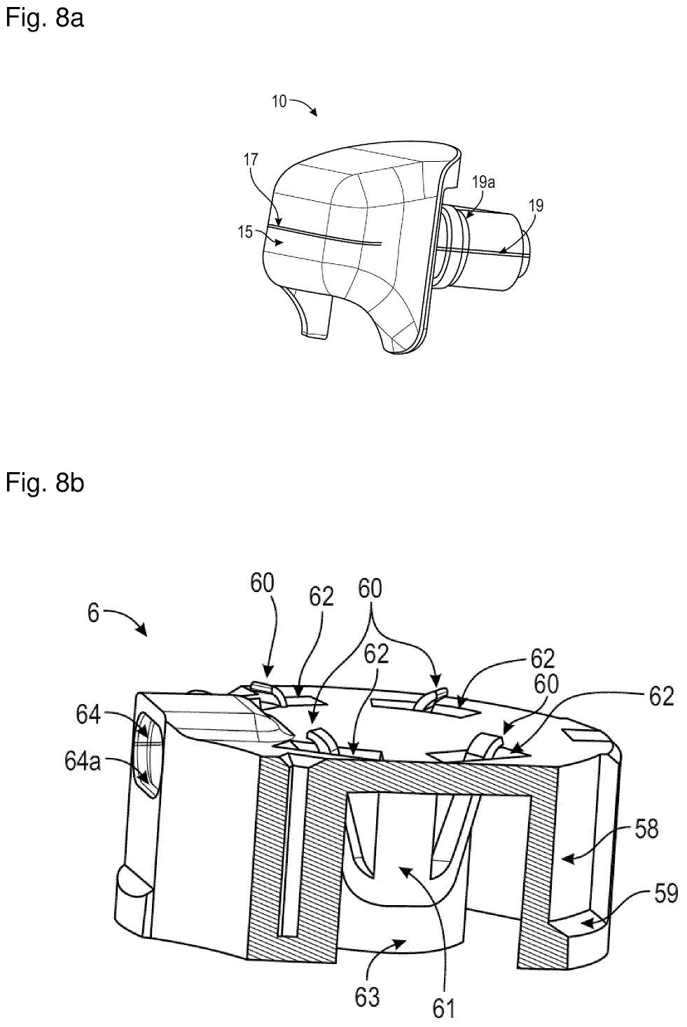

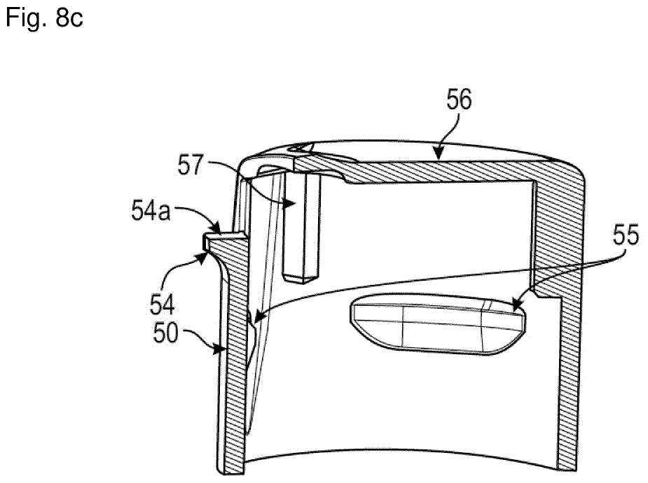

FIGS. 7 to 8c illustrate a dispensing head 2 according to a second embodiment of the present invention.

With reference to FIG. 7, in this embodiment, the dispensing head 2 is configured so that, when the pusher 5 is moved between the high position P_{H} and the low position P_{B}, the elastic nozzle 10 passes from a closed position in which said nozzle is sealed to an open position allowing the dispensing of said product by deformation of said nozzle 10 under the effect of a release of a stress exerted by the pusher 5. In this embodiment, as in the previous one, the opening of the nozzle 10 is therefore mechanically controlled. However, in this second embodiment, the pusher 5 exerts a stress on the nozzle 10 when the device is at rest and it is the release of the stress that allows the nozzle to pass from the closed position to the open position. This favours a tight seal in the closed position. The following sections describe in more detail how the stress exerted by the pusher 5 on the nozzle 10 is released.

As illustrated in FIG. 7, in this embodiment, the pusher 5 comprises an outer lateral surface 50 and a tongue 54 projecting from the outer lateral surface 50. The nozzle 10 projects radially with respect to the pusher 5. When at rest, i.e. when no pressure is exerted on the pusher 5, the nozzle 10 rests at least partly on the tongue 54, in particular on an upper surface 54a of the tongue (FIG. 8c). In other words, at rest, the nozzle 10 rests on the upper surface 54a. At the same time, this also means that the tongue 54 exerts a stress on the nozzle 10.

In addition, the dispensing head 2 advantageously comprises an insert 6. The insert 6 is made of a more rigid material than the nozzle 10. When at rest, the insert 6 exerts a stress on the nozzle 10 in the opposite direction to the stress exerted by the pusher 5. This is due, on the one hand, to the positioning of the insert 6 in relation to the pusher 5 and the nozzle 10 and, on the other, to the configuration of the insert 6 itself.

In this respect, the insert 6 advantageously comprises a plurality of elastically deformable legs 60. At rest, at least one of said legs 60, in this case all of said legs, exerts a stress on the nozzle 10 in the opposite direction to the stress exerted by the tongue 54 of the pusher, by resting against an internal face of an upper wall 56 of the pusher 5. These two opposing stresses allow the nozzle 10 to be sealed. Indeed, as is better illustrated in FIG. 8a, in the second embodiment, the nozzle 10 comprises a flexible web 15 comprising a slot 17 extending in a direction substantially transverse to the direction of movement of the pusher 5. In this case, the slot 17 extends substantially horizontally. Thus, at rest, the stresses simultaneously exerted by the tongue 54 of the pusher and by the deformable legs 60 of the insert are balanced to keep the lips of the slot 17 pressed against each other. This ensures an excellent sealing of the slot.

In the example of embodiment shown in FIG. 8b, the insert 6 comprises four elastically deformable legs 60. The elastically deformable legs 60 are connected in pairs by means of two spacers 61 and form pairs. Each leg 60 comprises one end connected to one of the spacers 61 and a free end which is curved outwards. Each elastically deformable leg 60 flares out between the end connected to the spacer 61 and the free end, conferring each pair of legs a substantially V-shape with the junction located at the level of the spacer 61. The free ends come to rest against the upper wall 56 of the pusher. The insert 6 comprises an upper face comprising a plurality of openings 62 through which said free ends can protrude and bend.

Each of the spacers 61 is positioned so that the two legs 60 which it ensures the connection exert a stress on the nozzle 10 in the opposite direction to the stress exerted by the tongue 54. The segments 61 of material are positioned on the insert 6 so that the legs 60 each exert a stress at locations substantially the same distance apart with respect to a plane of symmetry of the insert 6 passing through the central axis X of the dispensing head 2. This allows to ensure that the stresses exerted on the nozzle 10 are evenly distributed. Thanks to such an arrangement, the lips of the slot 17 are evenly plated along its entire length.

In FIG. 8b, it can be seen that the insert 6 comprises an opening 64 receiving the nozzle 10, here radially. More specifically, the opening 64 receives a segment 19 for connecting the nozzle (visible in FIG. 8a). It comprises attachment means 19a cooperating with attachment means 64a of the insert, which allows to ensure a good positioning of the nozzle 10. The insert 6 also comprises a substantially cylindrical chimney 63, the internal dimensions of which are adapted to those of an upper segment of the dispensing pump 3 in order to accommodate said upper segment of the pump. The chimney 63 is oriented along the axis of operation of the dispensing head. It comes from the upper face comprising the openings 62. In the illustrated embodiment, the spacers 61 also refer to the upper face comprising the openings 62, for example parallel to said chimney 63. Said spacers 61 are radially offset, outwardly, with respect to said chimney 63. The legs 60 extend from free ends of said spacers 61.

Preferably, the pusher 5 also comprises rest abutments 55 on which the insert 6 can be supported by a lower edge of a peripheral wall. Preferably, at rest, the pump is in an abutment position and does not exert any upward force on the insert 6. Under the effect of the legs 60 cooperating with the wall 56, the insert 6 is pressed against the rest abutments 55. The abutments 56 define an inner volume of the pusher 5 in which the insert 6 can displace axially. The peripheral wall of the insert 6 extends axially from the upper wall of said insert. It is offset radially outwards with respect to the legs 60.

Preferably, the pusher 5 comprises ribs 57 for angular positioning of the insert 6. Said ribs extend from the inner lateral flanks of the pusher 5 and cooperate with axially oriented gorges 58 provided at the level of an external face of the peripheral wall of said insert 6. Said ribs 57 and said gorges 58 allow the insert 6 to be guided relative to the pusher 5 during their relative axial movement. Preferably, said gorges 58 have an abutment surface 59 extending radially outwards so as to cooperate with a lower edge of the ribs 57 when the pusher 5 is operated, the insert 6 then being locked in an high position after the legs 60 have been bent.

When the user applies a pressure to the pusher, i.e. presses on an external surface of the upper wall 56, the pusher 5 displaces to the low position P_{B}. As the free ends of the legs 60 are bent outwards and are located against the upper wall 56 of the pusher and, at the same time, the other ends of the legs 60 are connected to the spacers 61, each pair of legs 60 will deform from a substantially V-shape, as described above, to a more flattened V-shape. The V-shape is referred to be flatter than the original V-shape because the free ends of the flatter V-shape are even further away from the spacers 61 than in the original V-shape configuration.

Thanks to such a configuration, when the user exerts a pressure on the pusher 5, the legs 60 deform elastically so that the insert 6 moves closer to the upper wall 56 of the pusher 5, according to a relative axial movement of the insert 6 with respect to the pusher 5. The nozzle 10 thus lifts off the tongue 54, in particular its upper surface 54a, and the slot 17 opens, in the absence of the now vanished stresses. Her lips are no longer pressed together.

It should be noted that the deformation of the legs 60 and the deactivation of the stress or stresses exerted by said legs is also due to the fact that their stiffness constant is appropriately selected in relation to a spring 35 of the pump 3. This is because the pump spring 35 has a stiffness constant chosen so that when the pusher 5 is operated, the force exerted by the legs 60 is less than the force exerted by the pump spring 35. At rest, as no stress is exerted on the pusher 5 and the pump is in abutment, the insert 6, by means of legs 60, exerts a downward stress on the nozzle 10 while the tongue 54 exerts an upward stress, in the manner of a pinch. On the other hand, when the pusher 5 is operated, the force exerted by said pump spring 35 is greater than that exerted by the legs 60 and the insert 6 moves closer to the upper wall 56 of the pusher 5. At the same time, the pump spring 35 has a suitable stiffness to keep its ability to compress and allow the pump 3 to be operated in order to dispense the product once the slot 17 is open.

In any case, by ceasing to press the pusher 5, the insert 6 returns to its original configuration, which allows the nozzle 10 to be closed mechanically. The opening and the closing of the nozzle 10, in particular of the slot 17, is not dependent on the pressure exerted by the fluid but on the mechanical stresses exerted on the nozzle 10.

When the nozzle 10 is lifted off with respect to the tongue 54, which remains light, the seal is favoured by the shape of the nozzle 10, which is provided extending on the surface in front of the tongue 54, under the slot 17.

The configurations shown in the cited figures are only possible examples, in no way limiting, of the invention which, on the contrary, encompasses the variations of shapes and designs within the reach of the person skilled in the art.

1. A head for dispensing a fluid product comprising:
a manually operable pusher, the pusher being configured to move between a high position (P_{H}) and a low position (P_{B}); and
a nozzle for dispensing the fluid product made of an elastic material,
the dispensing head being configured so that, during the movement of the pusher between the high position (P_{H}) and the low position (P_{B}), the nozzle passes from a closed position in which the nozzle is sealed to an open position allowing the dispensing of the fluid product by deformation of the nozzle under the effect of a stress exerted by a support or of a release of a stress exerted by the pusher.

2. The dispensing head according to claim 1, wherein the nozzle comprises a slot, the slot being configured to deform, along a circumferential direction, to allow the nozzle to pass from the closed position to the open position.

3. The dispensing head according to claim 2, wherein the nozzle is subjected to forces in opposite orientations involving the pusher to cause the slot to open or to maintain the slot closed by pinching.

4. The dispensing head according to claim 1, wherein the nozzle is made of a thermoplastic elastomer material having a shore hardness between 15 and 90 shore A.

5. The dispensing head according to claim 2, wherein the nozzle is attached to the pusher and comprises a means, referred to as movable, able to cause the nozzle to pass from the closed position to the open position.

6. The dispensing head according to claim 5, wherein the movable means consists of a boss located under and in contact with the nozzle, the boss comprising a surface adapted to come against the support.

7. The dispensing head according to claim 5, wherein the nozzle comprises a flexible web pinched between a boss and an upper peripheral border of the nozzle, the flexible web comprising the slot extending in a direction substantially identical to a direction of movement of the pusher, the slot being configured to deform to allow the nozzle to pass from the closed position to the open position under the effect of a force transmitted by the boss.

8. The dispensing head according to claim 7, wherein the nozzle comprises a dispensing portion equipped with the slot and with a conduit opening onto the slot, the nozzle further comprising an elastic member comprising two elastic legs adapted to be inserted in two housings of the dispensing portion extending on each side of the conduit and wherein a distance (d′) separating the two elastic legs is less than a distance (d″) separating the housings of the dispensing portion.

9. The dispensing head according to claim 1, wherein the support comprises a means, referred to as stationary, able to cause a passage of the nozzle from the closed position to the open position.

10. The dispensing head according to claim 2, further comprising an insert configured to exert a stress in the opposite direction to the stress exerted by the pusher to maintain the nozzle closed at rest.

11. The dispensing head according to claim 10, wherein the pusher comprises a tongue, the insert being equipped with a deformable leg or legs, the leg or legs causing a force so that the insert exerts on the nozzle a stress in the opposite orientation to a stress exerted by the tongue.

12. The dispensing head according to claim 11, wherein the legs are adapted to deform when a pressure is exerted on the pusher, the tongue ceasing to exert on the nozzle the stress in the opposite orientation to the stress exerted by the insert, when the pusher is actuated.

13. The dispensing head according to claim 12, further comprising a dispensing pump equipped with a spring, the spring having a stiffness constant selected so that upon the operating of the pusher, a force exerted by the legs is less than a force exerted by the spring.

14. The dispensing head according to claim 11, wherein the slot extends in a direction substantially transverse to a direction of movement of the pusher, the slot passing through a plane (P) referred to as plane of the slot, the direction of the stresses exerted by the tongue and the legs being orthogonal to the plane of the slot.

15. A bottle for dispensing a fluid product comprising:
a tank in which the fluid product is to be packaged; and
a neck equipped with a dispensing head according to claim 1.

16. The dispensing head according to claim 3, further comprising an insert configured to exert a stress in the opposite direction to the stress exerted by the pusher to maintain the nozzle closed at rest.

17. The dispensing head according to claim 4, further comprising an insert configured to exert a stress in the opposite direction to the stress exerted by the pusher to maintain the nozzle closed at rest.

18. The dispensing head according to claim 6, wherein the nozzle comprises a flexible web pinched between the boss and an upper peripheral border of the nozzle, the flexible web comprising the slot extending in a direction substantially identical to a direction of movement of the pusher, the slot being configured to deform to allow the nozzle to pass from the closed position to the open position under the effect of a force transmitted by the boss.

19. The dispensing head according to claim 12, wherein the slot extends in a direction substantially transverse to a direction of movement of the pusher, the slot passing through a plane (P) referred to as plane of the slot, the direction of the stresses exerted by the tongue and the legs being orthogonal to the plane of the slot.

20. A bottle for dispensing a fluid product comprising:
a tank in which a product is to be packaged; and
a neck equipped with a dispensing head for dispensing the fluid product, comprising:
a manually operable pusher, the pusher being configured to move between a high position (P_{H}) and a low position (P_{B}); and
a nozzle for dispensing the fluid product made of an elastic material,
the dispensing head being configured so that, during the movement of the pusher between the high position (P_{H}) and the low position (P_{B}), the nozzle passes from a closed position in which the nozzle is sealed to an open position allowing the dispensing of the fluid product by deformation of the nozzle under the effect of a stress exerted by a support or of a release of a stress exerted by the pusher.
